(19) United States
(12) Patent Application Publication
(10) Pub. No.: US 2007/0240527 A1
(43) Pub. Date: Oct. 18, 2007

(54) Cytology microarray maker and methods related thereto

(76) Inventors: Calum E. MacAulay, Vancouver (CA); Jagoda Korbelik, Vancouver (CA); Mark Cardeno, Surrey (CA)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/285,839

(22) Filed: Nov. 23, 2005

Related U.S. Application Data
(63) Continuation of application No. 10/176,389, filed on Jun. 19, 2002, now abandoned.
(60) Provisional application No. 60/298,911, filed on Jun. 19, 2001.

(51) Int. Cl. G01N 1/00; G01N 1/02

(52) U.S. Cl. 73/863; 422/100

(57) ABSTRACT

Microvolume liquid dispensers that provide simple and inexpensive approaches to making cytology microarrays. In some embodiments, the dispensers comprise tips that comprise an outer sleeve, typically shaped like a funnel, that holds a reciprocating needle or pin. The tip of the pin slightly extends beyond the distal opening of the outer sleeve in one position, and is retracted in another position. When the pin is in the distal position the pin contacts the inner surfaces of the sleeve and blocks cytology liquid from flowing through the opening of the sleeve. Thus the pin and sleeve cooperate to form a reservoir behind the blockage. When the pin is pushed up into the sleeve, for example by touching the tip to a glass slide, a passage is formed between the outer surface of the pin and the inner surface of the sleeve. The liquid in the reservoir then flows through the passage and onto the slide. Removing the tip from the substrate moves the pin back to its original position, re-forming the reservoir and leaving a predetermined microvolume amount of the liquid on the slide.

### CROSS-REFERENCE TO RELATED APPLICATIONS

The present application claims priority from U.S. provisional patent application No. 60/298,911, filed Jun. 19, 2001.

### FIELD

The field of the present application is micropipettes and microarrays.

### BACKGROUND

A “microarray” is a device that is used in biotechnology and other science research. A microarray can be made by putting a large number of tiny samples on a microscope slide (usually made of glass, nylon, plastic, metal, etc.). In a “cytology microarray,” the samples are typically individual cells or groups of cells (or disrupted tissue) in a solution such as water and alcohol. In a “tissue microarray,” the samples are typically whole tissue (as opposed to the substantially free-floating cells in a cytology microarray). In order to examine the samples in microarray closely, the microarrays are typically stained with special dyes, and/or probed with DNA, proteins or antibodies (or other probes). The microarrays are then examined under a microscope or in a specialized kind of computerized microscope called an image cytometer. This can determine the makeup or identity of the cells or tissues under review. This can be helpful for a variety of medical purposes, such as identifying or diagnosing diseases.

Tissue microarrays are sometimes advantageous because they keep the cells in their original tissue structure, and thus keep them in their original relationship with each other. However, tissue microarrays can be difficult to create and to assay because they can suffer from problems, known as “artifacts.” For example, when the cells are cut into thin sections, individual cells may be cut in half and thus important information can be lost. When the tissue is cut in thick sections it can be difficult to see the cells, and determine where one cell ends and another begins, because the cells overlap. Further, the tissue sections for one microarray are never precisely the same as the tissue sections for the next microarray because the microarrays are cut from different layers of the tissue. As a loose analogy, this is similar to a loaf of sliced bread. Each slice is a little bit different from the previous slice, and sometimes, in just one slice, the bread changes from middle pieces to an end piece, or even to nothing at all (once the loaf is finished). The same kind of thing happens with the individual cells in the tissue microarrays; the cells in one slice are not the same as the cells in the next slice. Tissue microarrays are also typically expensive to create.

Cytology microarrays, where the cells have been separated from each other and suspended in a suitable liquid, can be advantageous because they can be less expensive to make, and typically the cells can be put down on the slides in a “monolayer,” which means in a single layer so that there is little overlap of one cell and the next. However, making such cytology microarrays can also be expensive and difficult, for example because of inconsistent dispensing of the micro-volumes of liquid used for the cytology microarrays.

Accordingly, there is gone unmet a need for inexpensive and simple methods and devices for making cytology microarrays. The present systems and methods provide these and other advantages.

### SUMMARY

The microvolume liquid dispensers disclosed herein provide simple and inexpensive approaches to making cytology microarrays. Briefly, the tips comprise an outer sleeve, typically shaped like a funnel, that holds a needle or pin. The pin moves back and forth inside the sleeve, or reciprocates. The tip of the pin slightly extends beyond the distal opening of the outer sleeve in one position, and is retracted in another position. When the pin is in the extended, or distal, position the shoulders of the pin contact the inner surfaces of the sleeve and block the cytology liquid from flowing through the opening. Thus the pin and sleeve cooperate to form a reservoir behind the blockage. When the pin is pushed up into the sleeve by touching the tip to a glass slide or other substrate, a passage is formed between the outer surface of the pin and the inner surface of the sleeve. The liquid in the reservoir then flows through the passage and onto the slide. Removing the tip from the substrate moves the pin back to its original position, re-forming the reservoir and leaving a precise droplet of liquid—a predetermined microvolume amount of the liquid—on the slide.

The size and shape of the pin and sleeve can be cooperatively configured in any desired shape so that a precise amount of liquid flows from the reservoir when the tip is contacted with the substrate. Although a wide variety of additional attachments, such as springs or other biasing members, automated motion detectors, etc., can be provided and added, it is an advantage of the present tips that they do not need such attachments; they can be nothing more than routine plastic micropipette tips and simple metal needles (any other desired material can be used for either the sleeve or the pin), and the device can, if desired, be operated solely via manual operation and the effects of gravity.

In one aspect, the present disclosure provides a microvolume liquid dispenser comprising a body, an outer sleeve extending from the body, and a reciprocating pin located within the outer sleeve. The outer sleeve comprises a distal opening and the pin reciprocates relative to the sleeve between a distal position wherein a distal tip of the pin extends beyond the distal opening and a proximal position. The outer sleeve and the reciprocating pin can be configured to cooperatively form a reservoir when the pin can be in the distal position and configured to cooperatively dispense, through a passage formed between a side of the distal opening and the pin, a predetermined microvolume amount of liquid from the reservoir when the pin moves in a cycle from the distal position to the proximal position then returns to the distal position.

In some embodiments, wherein the dispenser can be a hand-held dispenser and the body comprises a handle, or the dispenser can be stationary and the body can be attached to a frame sized to fit on a substantially flat surface. (Unless expressly stated otherwise or clear from the context, all embodiments, aspects, features, etc., can be mixed and matched, combined and permuted in any desired manner.) The sleeve and pin can be configured to cooperatively dispense a volume per cycle that is suitable for a cytology microarray, and the passage can be sized to substantially avoid clogging by cells. The sleeve and pin can be configured such that the predetermined microvolume amount can be from about 0.05 μl to 0.5 μl per cycle, or otherwise as desired. The dispenser can further comprise a biasing element operably connected to at least one of the body and the outer sleeve and configured to urge the pin toward the distal position.

In another aspect, the present disclosure provides a microvolume liquid dispenser tip comprising an outer sleeve and a reciprocating pin located within the outer sleeve, configured to cooperatively interact as discussed above. The inner surface of the sleeve, and the sleeve itself, can be substantially frustoconical and the outer surface of the pin can be correspondingly substantially frustoconical. The substantially frustoconical shape of the pin can comprise a concave curve near the distal tip. The distal opening of the sleeve can have a diameter from about 0.5 mm to 1.5 mm. The tip can be one of an array of the microvolume liquid dispenser tips, which array can be configured and sized to make a cytology microarray.

In a further aspect, the present disclosure provides a cytology microarray maker comprising a frame operably connected to a body holding an array of microvolume liquid dispenser tips, at least two stages sized to support cytology microarrays, at least one upright member operably attached to the body to move the body and the array of tips substantially normal to the stages between at least an extended position wherein the tips contact a cytology microarray substrate located on the stage and a retracted position wherein the tips do not contact the cytology microarray substrate, and at least one axial member disposed along the frame and operably connected to the upright members to provide a track along which the upright members, the body and the array of tips can be movable along the track between the first and the second stage.

The microvolume liquid dispenser tips can be configured as discussed elsewhere herein or can be other configurations, and the maker can further comprise at least a third stage. The maker can be stationary and the frame can be sized to fit on a substantially flat surface or other surface as desired. The at least one axial member can comprise two rails extending along the frame, either separately from or as a part of the frame. The upright members can comprise two substantially planar elements slidably connected to the two rails and situated on either side of the stages, the substantially planar elements comprising corresponding elongated axial channels configured to slidably receive projections extending from the body. At least one of the frame and the upright members can be operably connected to body biasing element urging the body away from the stages.

The stages can be substantially planar stands and can further comprise at least x-axis and y-axis adjustment mechanisms configured to adjust positions of the stages relative to at least one of the frame and each other. The body can comprise a plurality of floating channels each sized to releasably hold one tip. The maker (as with other devices and systems herein) can be substantially automated or substantially manually operated.

The present disclosure also provides methods of dispensing a microvolume of liquid. The methods can comprise, a) providing a microvolume liquid dispenser tip as discussed herein; b) transiently contacting the distal tip and distal opening with a substrate thereby causing the pin to cycle; and, c) during the cycle, dispensing the liquid to the substrate. The sleeve and pin can be configured to cooperatively dispense a volume per cycle that is suitable for a cytology microarray. The tip can be one of an array of the tips, and the methods can comprise substantially simultaneously transiently contacting the array of tips with a cytology microarray platform, thereby causing the pin to cycle, and thereby forming the cytology microarray on the platform.

The methods can also comprise, before providing the tip containing the liquid, loading the liquid into the tip by placing the tip into a source of the liquid and suctioning up the liquid using capillary action. The tip can also be loaded by loading the liquid into the tip through a proximal opening located at a proximal area of the tip, or otherwise as desired.

The present disclosure further provides methods of making a cytology microarray comprising: a) providing a cytology microarray maker as discussed herein; b) loading the array of tips with liquid cytological specimens by transiently moving the array of tips into the liquid cytological specimens and suctioning up the liquid cytological specimens using capillary action; c) moving the array of tips along the axial member to the second stage; and, d) making the cytology array by transiently contacting the array of tips with the cytology microarray substrate. If desired, the microvolume liquid dispenser tips can comprise an outer sleeve and a reciprocating pin as discussed herein. The frame can further comprise a third stage, and the methods can comprise moving the array of tips along the axial member to the third stage; then making a second cytology array. The second cytology array can be made without reloading the tips.

The methods can comprise sliding the upright members along the two rails between the cytology microarray template and substrate, and then pushing the array downwardly (for example by pushing down on the array itself or on the body) to contact the cytology microarray template and substrate, respectively. The methods can also comprise adjusting the stages on at least one of an x-axis and a y-axis. Where the body comprises a plurality of floating channels each sized to releasably hold one tip, the methods can comprise placing the tips in the body to create the array of tips and removing the tips from the body after making the cytology array. The methods can also comprise removing the cytology array template and the cytology array from the stages then placing new cytology array substrates on the stages and making additional cytology arrays. The additional cytology arrays can be made without reloading the tips.

The present disclosure still further provides tip means for microvolume liquid dispensing comprising: a) an outer sleeve means for holding the liquid, b) a reciprocating pin means located within the outer sleeve for cooperatively dispensing, through a passage formed between a side of the outer sleeve means and the pin means, a predetermined microvolume amount of liquid when the pin moves in a cycle from a distal position to a proximal position then returns to a distal position. A means for making cytology microarrays can comprise: a) a frame means for holding a body means, b) the body means for holding an array of tips means for dispensing a microvolume of liquid, c) at least two stage means for supporting cytology microarrays, d) at least two upright member means operably attached to the body for moving the body means substantially normal to the stage means, and e) at least one axial member means disposed along the frame and operably connected to the upright members for moving the upright member means between the two stage means.

A methods of dispensing a microvolume of liquid can comprise the steps of: a) a step of providing a microvolume liquid dispenser tip means, as discussed herein, containing the liquid; b) transiently contacting the distal tip and distal opening with a substrate thereby causing the pin to cycle; and, c) during the cycle, dispensing the liquid onto the substrate. The sleeve means and pin means can be configured for cooperatively dispensing a volume per cycle that can be suitable for a cytology microarray, and the methods comprise the step of dispensing a spot of cell-containing liquid sized for the cytology microarray.

These and other aspects, features and embodiments are set forth within this application, including the following Detailed Description and attached drawings. In addition, various references are set forth herein, including in the cross-Reference To Related Applications, that discuss in more detail certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1 depicts schematically a microvolume liquid dispenser tip transiently contacting a cytology microarray substrate and dispensing a desired, predetermined microvolume amount of liquid.

FIG. 2 depicts schematically a microvolume liquid dispenser tip configured to dispense a smaller spot of liquid than the tip in FIG. 1.

FIG. 3 depicts schematically a microvolume liquid dispenser tip configured to dispense a larger spot of liquid than the tip in FIG. 1.

FIG. 4 depicts a hand-held micropipette comprising a microvolume liquid dispenser tip as discussed herein.

FIG. 5 depicts a schematically an elevated perspective view of various elements of a cytology microarray maker as discussed herein.

FIG. 6 depicts a front-side view of a cytology microarray maker.

FIG. 7 depicts a schematically an exploded, elevated perspective view of a tabletop suitable for use with the cytology microarray maker of FIG. 5.

FIG. 8 depicts a hand spotted cytology microarray with large spots, made using a funnel without a reciprocating pin.

FIG. 9 depicts a hand spotted cytology microarray with large spots, made using a funnel without a reciprocating pin.

FIG. 10 depicts a hand spotted cytology microarray with medium spots, made using a microvolume dispensing tip as discussed herein.

FIG. 11 depicts a hand spotted cytology microarray with small spots, made using a microvolume dispensing tip as discussed herein.

FIG. 12 depicts photomicrographs at different magnifications of a single spot from the cytology microarray of FIG. 8.

FIG. 13 depicts photomicrographs at different magnifications of a single spot from the cytology microarray of FIG. 11.

FIG. 14 depicts photomicrographs at different magnifications of a single spot from a cytology microarray with small spots made using a microvolume dispensing tip as discussed herein.

FIG. 15 depicts screen shots collected by an automated image cytometer for spots created using a funnel without a reciprocating pin.

FIG. 16 depicts screen shots of images collected by an automated image cytometer for spots made using a microvolume dispensing tip as discussed herein.

FIG. 17 provides graphs demonstrating spot sized in comparison to spot makers comprising a funnel only or comprising a funnel and needle and at different concentrations of cell concentration.

FIG. 18 depicts graphs indicating the effect of different alcohol and cellular concentration on spot size and liquid flow through the tips.

### DETAILED DESCRIPTION

High throughput genomic screening methodologies generate very large amounts of genetic, gene expression, and protein content information, and can be mined to determine possible markers (e.g., DNA sequence, mRNA, protein and antibodies to same) for a wide variety of clinical conditions (e.g., disease state, environmental induced damage, infection, or genetic susceptibility markers). Many of these markers can be evaluated, tested, verified and utilized on cellular material such as tissue sections, cytological preparations or extracted cellular components. It is generally accepted that many more markers will be suggested than will eventually be found to be clinically useful. Additionally, these markers are likely to be costly to manufacture and market. Thus, strategies that assist effective testing, verification and utilization of these markers would be of benefit. For these and other reasons, tissue microarrays are made from wax blocks that have tens to thousands of cylindrical tissue samples from random (cylinders adjacent to each other can be arbitrarily determined) arrangements of sources are constructed and used for these purposes. However, tissue microarrays have a number of drawbacks.

Cytology microarray provide a less labor-intensive, more uniform representation, and use less tissue from a sample. These arrays of spotted (deposited) cytological material may have from one to several thousands of sample cells per spot. The cells deposited may be unfixed, fixed, pre-processed disaggregated cells from solid tissue samples, etc. Each spot of cells may be from different sources, or may be from the same source, or some of each. The spots may be spatially distinct or over lapping. The spatial extent of each spot will be determined by the fluid containing the cells, the surface they are deposited onto and the environment in which they are deposited (humidity, temperature, vapor pressure of the atmosphere, etc.).

The systems and methods discussed herein provide simple and easy ways to make such cytological microarrays.

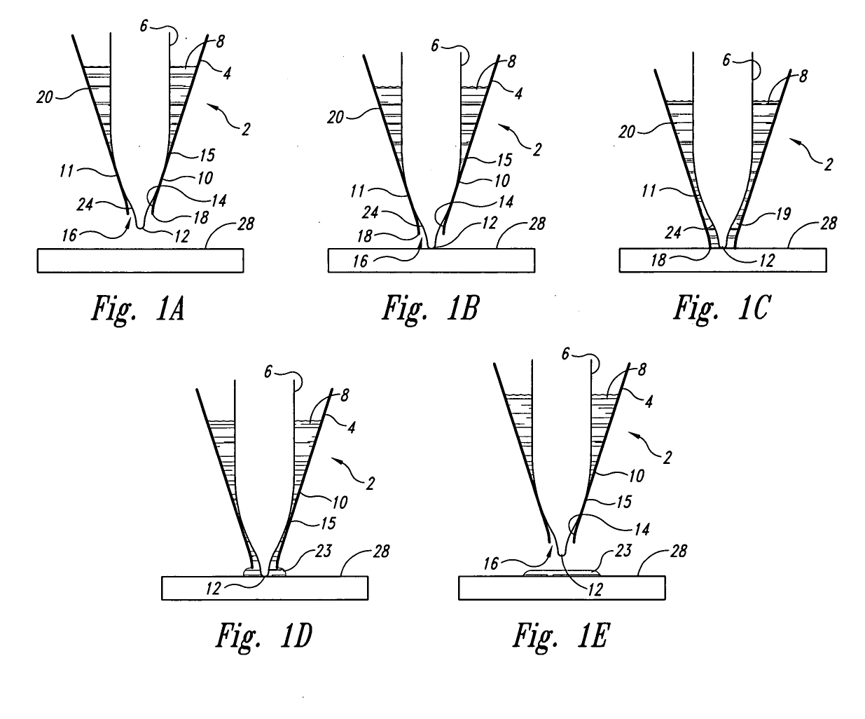

Turning to the Figures, FIGS. 1-3 each schematically depict one cycle of a microvolume liquid dispenser tip. In FIG. 1, for example, the microvolume liquid dispenser tip 2 has an outer sleeve 4 and a reciprocating pin 6. Reciprocating pin 6 is located within the outer sleeve, and may or may not be physically attached to outer sleeve 4. Outer sleeve 4 comprises a distal opening 16 and an inner surface 14. As depicted, outer sleeve 4 is substantially frustoconical, ending in distal opening 16; other shapes are possible as desired. Reciprocating pin 6 comprises an outer surface 10, a shoulder 11 and a distal tip 12. As depicted, the shoulder 11 and distal tip 12 provide a substantially frustoconical form to reciprocating pin 6. As can be seen in the Figure, in this embodiment shoulder 11 further provides for a concave curve 24 near distal tip 12.

When reciprocating pin 6 is in a distal position with respect to outer sleeve 4, the outer surface 10 of reciprocating pin 6 contacts an inner surface 14 of outer sleeve 4 to substantially form a seal 15 at the point of contact. Because of the seal 15, any liquid maintained proximal to the seal 15 forms a reservoir 8. When reciprocating pin 6 is moved proximally relative to outer sleeve 4, a passage 19 is created between reciprocating pin 6 and a side 18 of distal opening 16 of outer sleeve 4. Accordingly, liquid, which in FIG. 1 is a cytological fluid 20, can flow through passage 19 to reach cytology platform 28 which, as embodied in FIG. 1, is a substantially planar substrate. If desired, other forms of substrate, such as substantially spherical or otherwise curved substrates as may be found in the bottom of certain wells of desirable microarray substrates, such as 96-well plates, are also suitable for use. Passage 19 can be sized to substantially avoid clogging by the cells when the liquid being dispensed is a cytological fluid.

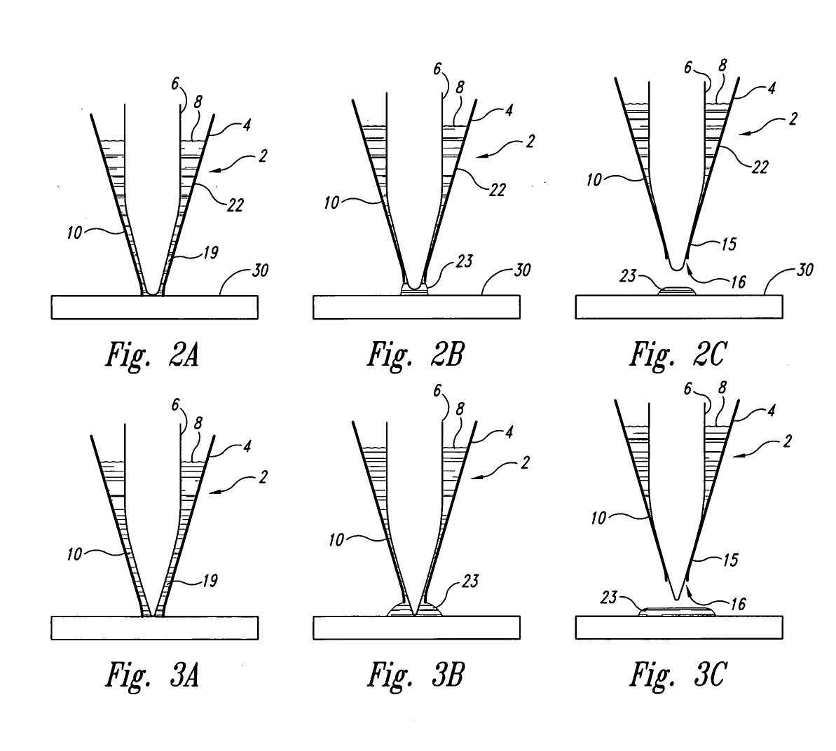

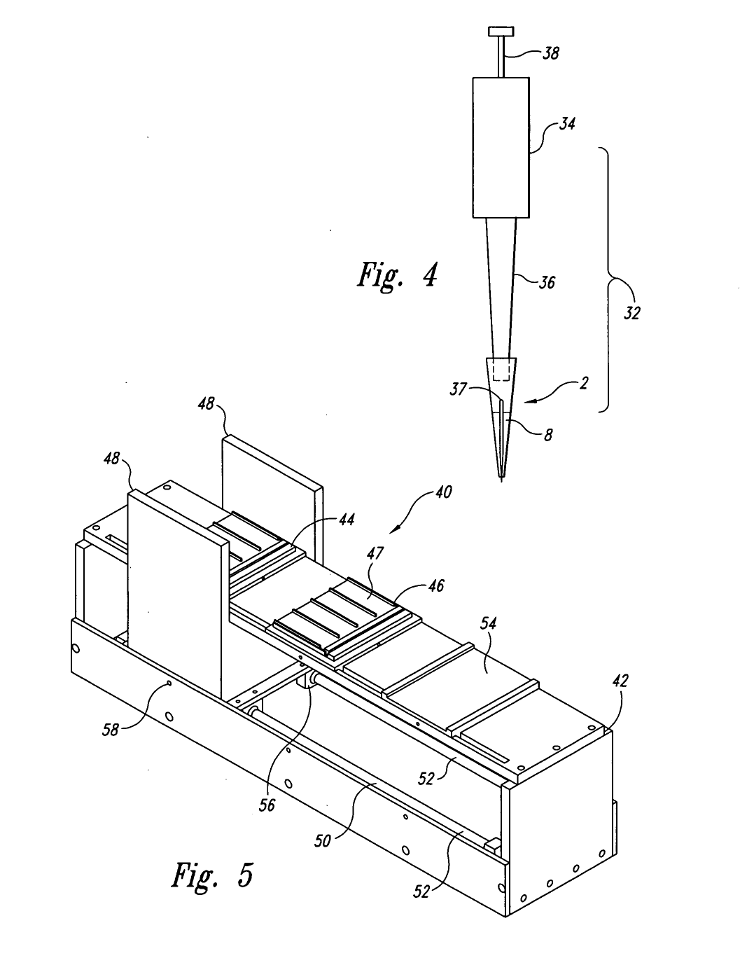

If desired, the reciprocation of reciprocating pin 6 can be caused by various assorted attachments to either the outer sleeve or the pin, for example a biasing element 37 as depicted in FIG. 4, but it is a feature and an advantage of the present systems and methods that no additional elements are necessary to provide the precisely dispensed quantities of cytological fluids or other chemical solutions (such as chemical solution 22 dispensed onto substrate 30 in FIG. 2). Thus, it is inexpensive and easy to move reciprocating pin 6 in a cycle from the distal position to the proximal position and then back to the distal position simply by contacting the dispenser tip 2 with the desired substrate. Similarly, it is possible to load the tip with a liquid merely by placing the tip into the source of the liquid and suctioning up the liquid using capillary action. Conversely, if desired, the liquid may be loaded into the tip through a proximal opening located at a proximal area of the dispensing tip, 2 for example at the top of dispensing tip 2 where it abuts body 36 in FIG. 4.

The result of moving the reciprocating pin through a cycle is the dispensing, and typically deposit, of a spot of the desired fluid onto the receiving surface such as the cytology platform 28 or substrate 30 depicted in FIGS. 1-3. Thus, a spot 23 is formed on the receiving surface. The spot can be of medium size, as depicted in FIG. 1, of small size as depicted in FIG. 2, or of a large size as depicted in FIG. 3. Generally, the spots comprise from about 0.05 μl to about 0.5 μl with a typical spot being about 0.1 μl. The spots be either larger or smaller if desired. Typically, depending upon the desired format, the solution comprising the cells (or other chemical solution if not a cytological application), the distal opening diameter will typically be from about 0.5 mm to about 1.5 mm, for example about 0.83 mm to 1 mm.

As already noted, the distal tip 12 of reciprocating pin 6 extends beyond the distal opening 16 of outer sleeve 4. Such extension can be effected by a single point of reciprocating pin 6, or reciprocating pin 6 can be shaped to provide a plurality of points or otherwise configured to extend beyond distal opening 16. Typically reciprocation pin 6 and distal tip 12 are unitary, but if desired they can be operably connected to provide the same functions (indeed, for example where the tip is designed to be used with a deep well plate such as certain 96 -well plates, the distal tip may be configured to contact the side of the well as opposed to the bottom of the well yet still releasing the fluid at the desired point, for example substantially when the dispensing tip 2 contacts the bottom of the well (or other desired location).

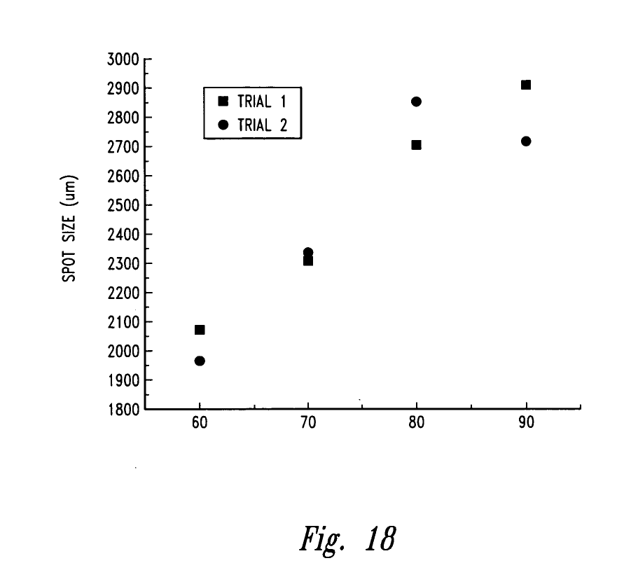

The spot size can be controlled by a variety of factors in addition to the size of the reciprocating pin 6 in the outer sleeve 4. For example, as depicted in FIG. 18, spot size can be affected by alcohol to water concentration, the concentration of cells, or other factors as desired. In view of the present application, a skilled person will be able to control the spot size quite precisely.

FIG. 4 depicts a hand-held embodiment of the microvolume liquid dispenser discussed herein. In particular, hand-held micropipette 32 has a handle 34 and a body 36. As depicted, micropipette 32 additionally comprises a plunger 38 that is useful for typical operation of the micropipette but which is not necessary for the present systems for dispensing microvolumes of liquid.

FIG. 5 depicts a cytology microarray maker 40 having a frame 42. As depicted, frame 42 is sized to be stationary and fit on a substantially flat surface although it can be configured or sized to fit any desired surface. Maker 42 has a first stage 44 second stage 46 and third stage 54, each of which are capable of supporting or holding a cytology array template, cytology array substrate or other desired platform or surface. A cytology microarray template is a cytology microarray that comprises a plurality of liquid cytological specimens or other suitable samples (such as control samples or reference samples). This template can provide samples to the microvolume dispensing tips by transiently contacting the tips into the sample, i.e., the source of the liquid, and then suctioning up the liquid, for example by using capillary action, an active vacuum or otherwise as desired. It is an advantage of the present embodiment that enough liquid from the template can be loaded into the tips at one time to make a plurality of cytological microarrays without reloading. Accordingly, a plurality of different stains, probes or other investigative material can be used with different cytological microarrays but without significant variation in the samples in the microarrays, both in the volume of a given sample in the microarray and in the location of the samples in one microarray to another.

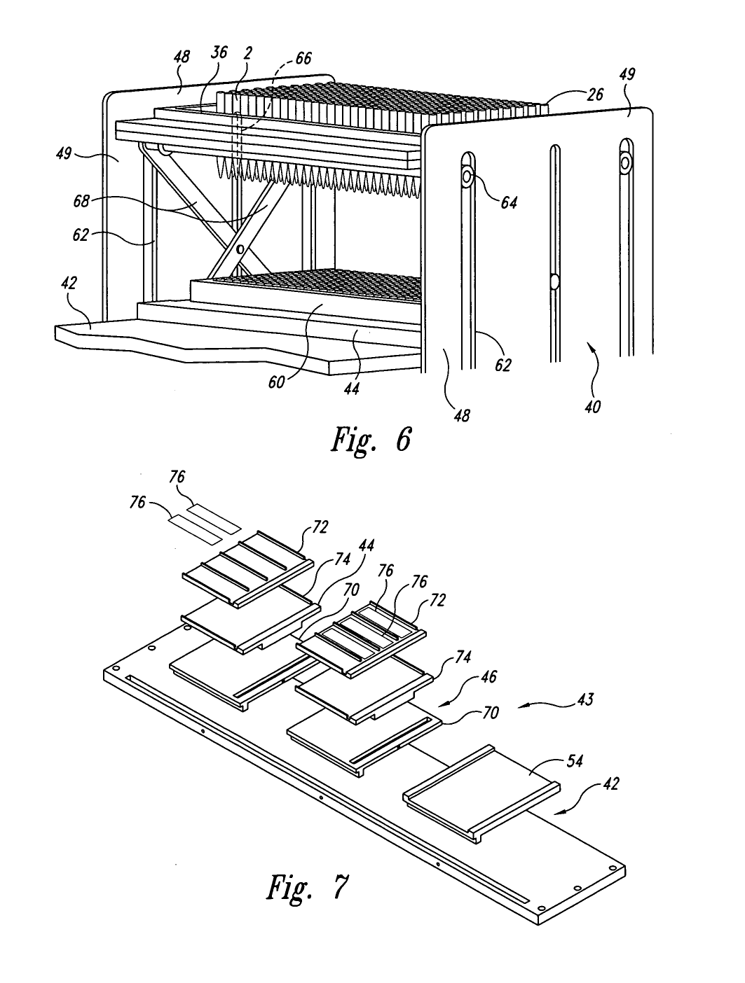

Cytology microarray maker 40 further comprises a body 36 that holds an array 26 of tips (see FIG. 6) between upright members 48. Frame 42 further comprises at least one axial member 50, which in the embodiment depicted comprises two rails 52 extending along frame 42. In FIG. 5, rails 52 are attached to the frame via rail attachments 56. Conversely, the rails 52 or other axial member 50 can be integrally formed in frame 42, for example being formed by the provision of axial slots along frame 42. Rails 52, or other axial member, provide a track disposed along the frame such that the array of tips, the body, the upright members 48, etc., are movable along the track between the various stages.

As depicted in FIG. 5, two sets of removable slide cards 47 are shown, one each above the first stage and second stage 46. Upright members 48, which as depicted are substantially planar elements 49 can be moved along frame 42 by pushing or pulling them-along rails 52. If desired, the positioning of the upright members 48 can be facilitated by the provision of retaining elements indicating when the upright members are in the proper location, for example by the provision of spring-loaded ball and indent centering and lock mechanisms, or any other desired positioning mechanism. The maker 40 in FIG. 5 also has a frame support 58 sized for a substantially planar surface.

FIG. 6 depicts a cytology microarray maker 40 comprising a body 36 holding an array of tips 26 and a cytology microarray template 60. Upright members 48 comprise substantially planar elements 49, which in turn comprise elongated axial channels 62. Substantially planar elements 49, are slidably connected to the rails 52 shown in FIG. 5, and are situated on either side of the stages. Elongated axial channels 62 provide locations configured to slidably receive projections 64 extending from body 36. FIG. 6 also depicts a floating channel 66 in dotted line for one of the tips 2; similar floating channels are provided for each of the microvolume dispenser tips in array 26 but not depicted. The floating channels are each sized to releasably hold one tip. If desired, two or more of the channels can be interlocked, provided that adequate spacing between the tips is maintained when moving the array 26 from one stage to another. Also depicted are body biasing elements 68 which urge the body 35 away from the various stages. This facilitates both loading the tips and making the microarrays because one need merely push down on the body to load the tips/dispense from the tips; the tips then automatically reciprocate away from the given cytology element upon release of the pressure. As depicted, the various embodiments are used in an orientation where gravity is below the tips and assists in maintaining the tips in place in the body and in maintaining the fluid in the reservoirs. It is possible to provide other orientations for the various elements if desired. In addition, the body 36 moves in an orientation that is substantially normal to the various cytology templates/substrates. As used herein, substantially normal includes angles other than 90 degrees if desired by the user.

FIG. 7 depicts a tabletop 43 suitable for use with, and comprising a part of, frame 42. In tabletop 43 as depicted, a variable Y adjustment device 70 and a variable X adjustment device at 74 are provided. Movement of these devices in the desired direction enhances the ability to precisely place templates and substrates under the body and array of tips. Also depicted are a plurality of cytological microarray substrates 76, in this case glass slides.

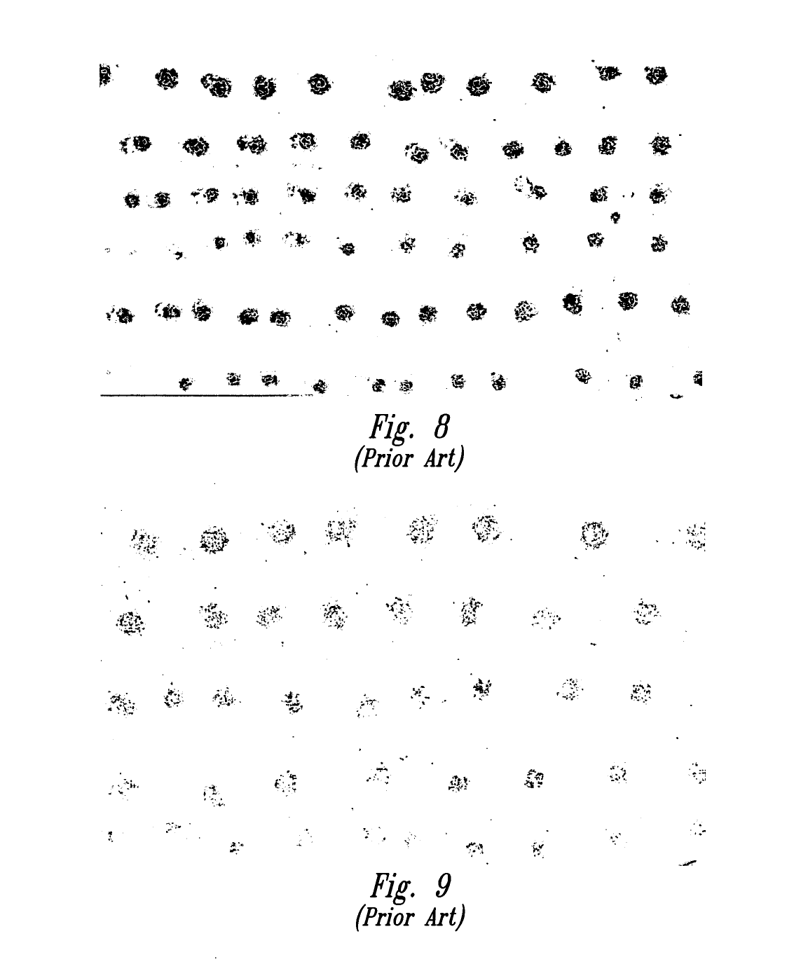

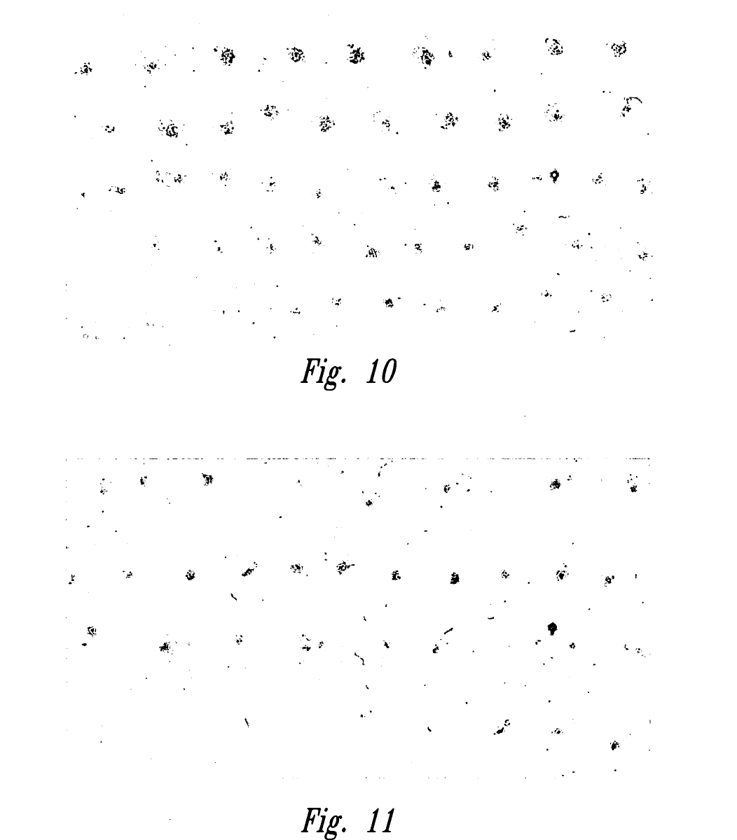

FIGS. 8-11 provides photographs of a variety of arrays made using various dispensing tips: In each of FIGS. 8-11, each of the spots provide a cytological specimen and has been stained with H & E. In FIGS. 8 and 9, the spots were made without using the reciprocating needle 6 discussed elsewhere and, as can be see, the spots are diffuse and large. In contrast, in FIGS. 10 and 11, medium and small spots were created using outer sleeves or funnels and reciprocating pins. Small pins and a high cell concentration solution were used to make medium spots in FIG. 10, and large pins and a high cell concentration solution were used to make small spots in FIG. 11.

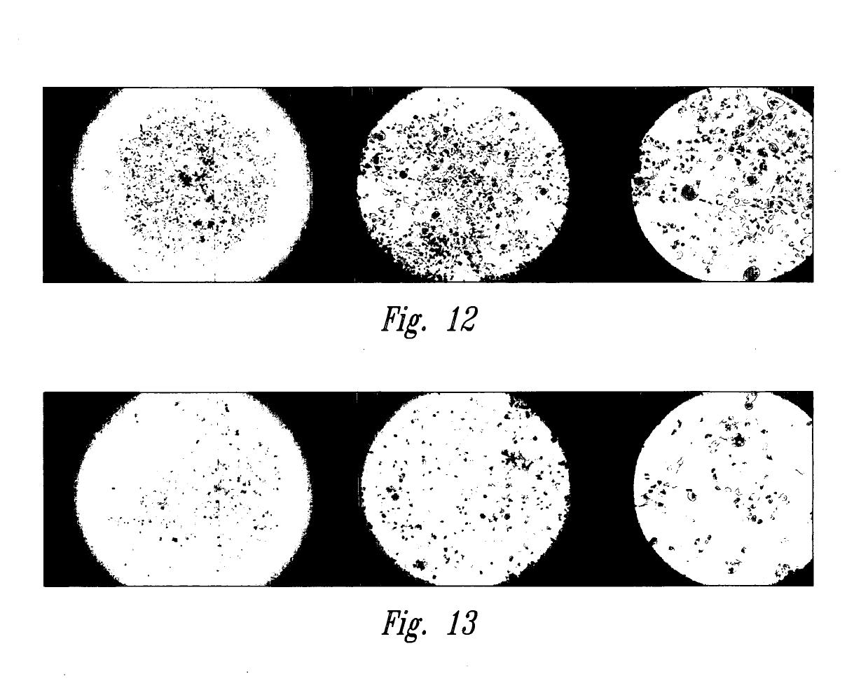

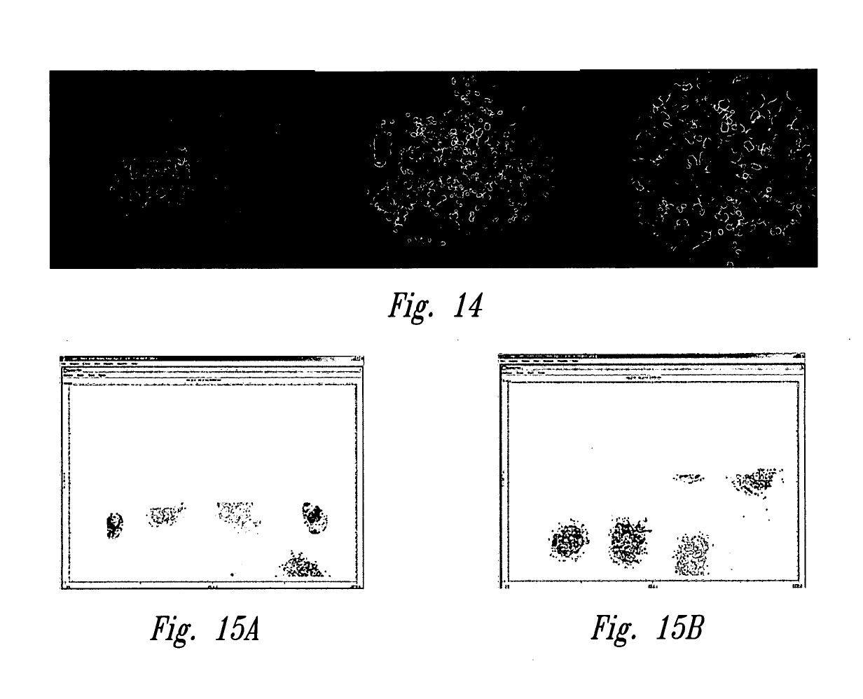

FIGS. 12 and 13 provide photomicrographs at various magnifications (4×, 10× and 20×) of a single spot from the cytological microarrays depicted in FIGS. 8 and 11 respectively. As can be seen, the spots in FIG. 13 are smaller, as can also be seen in FIG. 11, and the cells are not as clustered and there is reduced overlapping. Thus the cells are better capable of analysis using certain analysis methods such as certain image cytometry analyses. FIG. 14 also depicts a series of micrographs of magnification 4×, 10× and 20× of a single spot from a hand spotted cytology microarray that was stained with H & E wherein the microvolume dispensing tip had a large reciprocating pin and a low cell concentration solution.

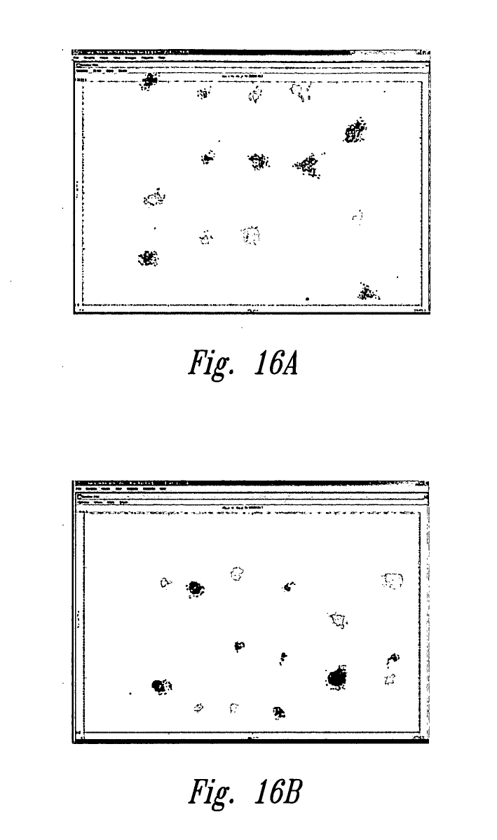

FIGS. 15 and 16 depict screen shots of cells images collected by an automated image cytometer. The Figures demonstrating the distribution of the images collected from the spots both with and without the cytological microvolume dispensing tip discussed herein. In FIG. 15, the spots were created using a funnel only, with out a reciprocating pin, whereas in FIG. 16 the spots were created using both the outer sleeve and the reciprocating pin (which was a small needle in this case). In each figure, low cell concentration solutions were used for the spots in the graphs on the left, high cell concentration solutions were used for the spots in the graphs on the right. As can be seen, the spots in FIG. 15 are significantly larger and the spots in FIG. 16 are better suited for some analyses than are the spots in FIG. 15.

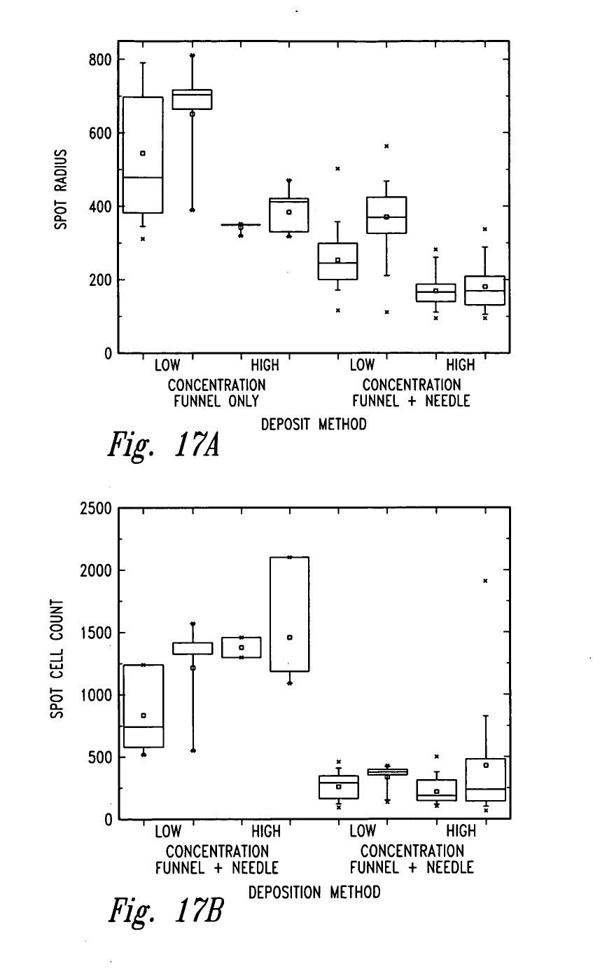

FIGS. 17 provides graphs depicting the distribution of cell images collected by an automated image cytometer wherein the spots were created using an outer sleeve only (on the left in each graph) and an outer sleeve with a small reciprocating pin (on the right in each graph). Two different cell concentrations were used for each pair in each graph, with low concentrations on the left and high concentrations on the right). The low cell concentrations, and the funnels without reciprocating pins created larger spots, with more cells imaged per spot. For the high cell concentration dispensed through a funnel with a reciprocating pin, the cell density was too high and it appears that the number of overlapping cell clusters artificially reduced the number of cells counted by the automated image cytometer. It appears that the cell concentration changes the viscosity of the solution and that the high concentration solution exhibits the characteristics of a viscous or slow spreading or rapidly evaporating solution.

In FIG. 18, different alcohol concentrations were used. As can be seen, increasing the alcohol concentration increased the spot size.

Turning to some additional discussion of various aspects, the amount of fluid deposited depends in part upon the shape of the outer sleeve and the shape of the reciprocating pin. The size to which the fluid spreads to create the spot depends in part on the suspension fluid, the type of planar surface, and the environment in which the process takes place. For example, low humidity, moderate temperature and a hydrophilic surface will cause the formation of a smaller spot than will high humidity, low temperature and a hydrophilic surface. Additionally, the suspension fluid may comprise rapidly drying fluids such as alcohol. The rate of spread of the fluid affects creation of a cellular monolayer. Too slow with the spreading and too fast with the evaporation with a high cell density will lead to many clumped, overlapping cells. Too fast with the spreading and too slow with evaporation will lead to larger than desired spots.

In addition to creating arrays of distinct spots on a planar surface, the same techniques and approach can be used to very rapidly turn a cell suspension into a spatially localized monolayer-type preparation for traditional cytological applications, as well as for automated quantitative cytological applications. This can be done by creating an area of spots that just touch or slightly overlap. These spots would be placed in an interleaved fashion such that new spots are either deposited on a virgin surface or adjacent to completely dry spots so as to create the optimal monolayer without causing all the deposited cells to bunch up along the edge or into clumps. The cytological preparation is typically disaggregated so as to not plug or clump up the outer sleeves or outer sleeve reciprocating pin combinations.

The outer sleeve or reciprocating pin outer sleeve combinations may also be used to disaggregate cytological samples by utilizing the shear forces involved in flowing the sample multiple times backwards and/or forwards through the outer sleeve or outer sleeve reciprocating pin combination. It is possible to create different controllable shear forces by varying the position of the reciprocating pin within the outer sleeve and by designing the shape of the reciprocating pin-outer sleeve contact areas appropriately.

The methodologies and systems herein can typically be. implemented in parallel such that many (2 to 32 or more) spots could be deposited in parallel.

Applications for cytology microarrays in addition to those discussed elsewhere herein include 1) Use with multiple FISH probes where one probe is applied to a cytology microarray comprising samples from multiple subjects; 2) Use with multiple messenger RNA probes for expression analysis from multiple subjects; 3) Use with disease markers across multiple subjects or samples to reduce cost and/or increase throughput; 4) Use with an automated cytometry device to allow ploidy data to be rapidly collected from many samples/subjects disposed on a single slide, which can assist in reducing slide-to-slide staining variations.

The ability to make many equivalent cytology microarrays confers other possibilities. For example, given 200 tumor samples which need to be examined for about 1000 genetic changes or about 1000 expression changes, one can disaggregate the samples, create 200 cell suspensions, deposit 200 spots (one per sample) on each of 1000 slides (one spot from each sample for each slide, 100 cells per spot for a total cell count of about 100,000 cells) and then mark each slide with either a specific FISH probe (1 or multicolor per slide) or a specific mRNA marker for expression analysis. Thus, instead of running 600 DNA tissue microarrays, each of which typically uses about 1 million cells costs more per slide than cytology microarrays, one can run 1000 cytology microarrays for less cost, in some cases possibly about 10% the cost.

The data produced by each of the tissue microarray and the cytology microarray would be the about same except with the cytology microarray DNA data one would have FISH spot counts which can detect single deletions very reliably, as well as be able to differentiate the contamination cells (stromal, connective tissue, blood, vessel wall, etc.) from the tumor cells, which could reduce the need for tissue microdissection. The differentiation could be on the basis of morphological features or various counter stains. For the expression data, the result could be intensity expression for individual cells in a spot, the average expression, and the variance of expression. Given that mRNA marker and DNA FISH probe staining processes do not interact significantly it would be possible to perform both tests on the same samples.

Thus, in one aspect, one can match the FISH probe to the expression marker, or otherwise match gene and protein expression assays, and do both gene and gene expression at the same time. Also at a later date as more specific protein markers become available, one could measure all three of gene, gene expression and gene product on the same cells at the same time.

The present systems and methods are also useful for combining cytology microarrays (or for that matter, tissue microarrays) with complex liquid handling. For example, it would be possible to take multiple specimens from a single sample the deposit (or block) many spots of cells (or tissue cores) on a slide or slides and then deposit fixed (typically very small) amounts (usually no more than a single drop) of different marker solutions on different tissue or cell spots on the slide. This allows the different markers to bind the cell components (DNA, mRNA, etc.). The cell markers are then typically washed off the slide. To reduce the risk of cross contamination of marker solutions to adjacent spots, the small amounts of marker solution could be removed using a blotter (wicking material) in soft contact with the slide to wick away most of the marker solution then wash the slide. In all of these applications, a flexible automated cytometer (transmission and fluorescence mode) would be extremely valuable to automate the interpretation of the slides.

To reduce the spot to spot contamination (of either fluids and cells) it can be beneficial to use a slide with a removable or non-removable mask that creates shallow or deep wells, then depositing one spot into each well. The mask would contain the cell spot as well as any added solutions. For an example of a masked slide with removable mask see U.S. Pat. No. 5,784,193.

Turning to some additional discussion of the methods herein, in some aspects the methods comprising dispensing a microvolume of liquid. Such methods can comprise a) providing a microvolume liquid dispenser tip as discussed herein, b) transiently contacting the distal tip and distal opening with a substrate thereby causing the pin to cycle, for example by briefly touching the tip and the substrate; and, c) during the cycle, dispensing the liquid to the substrate.

The sleeve and pin can be configured to cooperatively dispense a volume per cycle suitable for a cytology microarray, and the passage can be sized to substantially avoid clogging by the cells. The microvolume liquid dispenser tip can be one of an array of tips, the tips and array configured and sized to make a cytology microarray. The method can comprise substantially simultaneously transiently contacting the array of tips with a cytology microarray platform, thereby causing the pin to cycle, and thereby forming the cytology microarray on the platform.

The methods can also make cytology microarrays. Such methods can comprise providing a frame holding a body holding an array of microvolume liquid dispenser tips, at least first and second stages sized to support cytology microarrays, upright members operably attached to the body to move the body and tips substantially normal to the stages between at least an extended position wherein the tips contact a cytology microarray substrate located on the stage and a retracted position wherein the tips do not contact the cytology microarray substrate, and at least one axial member disposed along the frame and to move the upright members between the stages. The first stage holds a cytology microarray template comprising an array of liquid cytological specimens and the second stage holds a cytology microarray substrate. The tips in the array are then loaded with the liquid cytological specimens by transiently moving the array of tips into the liquid cytological specimens and suctioning up the liquid cytological specimens using capillary action. Next, the array of tips is moved to the second stage, where the cytology array is made by transiently contacting the array of tips with the cytology microarray substrate.

The frame can further comprises a third stage holding a cytology microarray substrate and a second cytology array can be made by moving the array to the third stage then transiently contacting the array of tips with the second cytology microarray substrate. In some embodiments, this can be done without reloading the tips. Additionally, the substrates and the template(s) can be removed or covered, then additional substrates can be provided and additional cytology arrays created. The method can further comprise adjusting the stages on at least one of an x-axis and a y-axis relative to at least one of the frame and each other. The methods can also comprise placing the tips in the body to create the array of tips and removing the tips from the body after making the cytology array. As with the devices herein, the methods can be either substantially manual or automated. If automated, the devices can be operably connected to a controller, which is a device that is capable of controlling various elements of the apparatus and methods discussed herein. For example, the controller can control the location and movement of the body, the loading of and dispensing from the tips, and the collection of images form a microarray. Typically, a controller is a computer or other device comprising a central processing unit (CPU) or other logic-implementation device, for example a stand alone computer such as a desk top or laptop computer, a computer with peripherals, a local or internet network, etc. Controllers are well known and selection of a desirable controller for a particular aspect or feature is within the scope of a skilled person in view of the present disclosure.

All terms used herein, including those specifically discussed below in this section, are used in accordance with their ordinary meanings unless the context or definition clearly indicates otherwise. Also unless indicated otherwise, except within the claims, the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural (for example, “a” means “at least one”) unless expressly stated, or the context clearly indicates, otherwise.

The scope of the present disclosure includes both means plus function and step plus function concepts. However, the terms set forth in this application are not to be interpreted in the claims as indicating a “means plus function” relationship unless the word “means” is specifically recited in a claim, and are to be interpreted in the claims as indicating a “means plus function” relationship where the word “means” is specifically recited in a claim. Similarly, the terms set forth in this application are not to be interpreted in method or process claims as indicating a “step plus function” relationship unless the word “step” is specifically recited in the claims, and are to be interpreted in the claims as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the present disclosure. Accordingly, the disclosure includes such modifications as well as all permutations and combinations of the subject matter set forth herein and is not limited except as by the appended claims.

1-14. (canceled)

15. A cytology microarray maker comprising:
a frame operably connected to a body, said body holding
an array of microvolume liquid dispenser tips;
a first stage sized to support a cytology microarray template and a second stage sized to support a cytology microarray substrate;
upright members operably attached to the body to move the body and the array of tips substantially normal to the stages between at least an extended position wherein the tips contact a cytology microarray substrate located on the stage and a retracted position wherein the tips do not contact the cytology microarray substrate; and
at least one axial member disposed along the frame and operably connected to the upright members to provide a track along which the upright members, the body and the array of tips is movable along the track between the first and the second stage.

16. The cytology microarray maker of claim 15 wherein the microvolume liquid dispenser tips comprise an outer sleeve and a reciprocating pin located within the outer sleeve, the outer sleeve comprising a distal opening and the pin reciprocating relative to the sleeve between at least a distal position wherein a distal tip of the pin extends slightly beyond the distal opening and a proximal position, wherein an inner surface of the sleeve and an outer surface of the pin are configured to cooperatively form a reservoir when the pin is in the distal position and wherein the sleeve and pin are configured to cooperatively dispense, through a passage formed between a side of the distal opening and the pin, a predetermined microvolume amount of liquid from the reservoir when the pin moves in a cycle from the distal position to the proximal position then returns to the distal position.

17. The cytology microarray maker of claim 15 or 16 wherein the maker further comprises a third stage sized to support a cytology microarray and the at least one axial member is configured to move the array of tips between the first, second, and third stages.

18. The cytology microarray maker of claim 15 or 16 wherein the maker is stationary and the frame is sized to fit on a substantially flat surface.

19. The cytology microarray maker of claim 15 or 16 wherein the at least one axial member comprises two rails extending along the frame.

20. The cytology microarray maker of claim 19 wherein the two rails form a part of the frame.

21. The cytology microarray maker of claim 19 wherein the upright members comprise two substantially planar elements that are slidably connected to the two rails and situated on either side of the stages, the substantially planar elements comprising corresponding elongated axial channels configured to slidably receive projections extending from the body, and at least one of the frame and the upright members comprises an operably connected body biasing element urging the body away from the stages.

22. The cytology microarray maker of claim 15 or 16 wherein the stages are substantially planar stands and further comprise at least x-axis and y-axis adjustment mechanisms configured to adjust positions of the stages relative to at least one of the frame and each other.

23. The cytology microarray maker of claim 15 or 16 wherein the body comprises a plurality of floating channels each sized to releasably hold one tip.

24. The cytology microarray maker of claim 15 or 16 wherein the maker is substantially automated.

25. The cytology microarray maker of claim 15 or 16 wherein the maker is substantially manually operated.

26-33. (canceled)

34. A method of making a cytology microarray comprising:
a) providing a frame holding a body holding an array of microvolume liquid dispenser tips, at least first and second stages sized to support cytology microarrays, upright members operably attached to the body to move the body and the array of tips substantially normal to the stages between at least an extended position wherein the tips contact a cytology microarray substrate located on the stage and a retracted position wherein the tips do not contact the cytology microarray substrate, and at least one axial member disposed along the frame and operably connected to the upright members to move the upright members, the body and the array of tips between the first and the second stage, wherein the first stage holds a cytology microarray template comprising an array of liquid cytological specimens and the second stage holds a cytology microarray substrate;
b) loading the array of tips with the liquid cytological specimens by transiently moving the array of tips into the liquid cytological specimens and suctioning up the liquid cytological specimens;
c) moving the array of tips along the axial member to the second stage; and
d) making the cytology array by transiently contacting the array of tips with the cytology microarray substrate;

35. The method of claim 34 wherein the microvolume liquid dispenser tips comprise an outer sleeve and a reciprocating pin located within the outer sleeve, the outer sleeve comprising a distal opening and the pin reciprocating relative to the sleeve between at least a distal position wherein a distal tip of the pin extends slightly beyond the distal opening and a proximal position, wherein an inner surface of the sleeve and an outer surface of the pin are configured to cooperatively form a reservoir when the pin is in the distal position and wherein the sleeve and pin are configured to cooperatively dispense, through a passage formed between a side of the distal opening and the pin, a predetermined microvolume amount of liquid from the reservoir when the pin moves in a cycle from the distal position to the proximal position then returns to the distal position, and wherein the transient contacting causes the pin to cycle.

36. The method of claim 34 or 35 wherein the frame further comprises a third stage holding a cytology microarray substrate and the at least one axial member is configured to move the array of tips between the first, second and third stages, and the method further comprises moving the array of tips along the axial member to the third stage; and making a second cytology array by transiently contacting the array of tips with the second cytology microarray substrate.

37. The method of claim 36 wherein the second cytology array is made without reloading the tips.

38. The method of claim 34 or 35 wherein the at least one axial member comprises two rails extending along the frame, the upright members comprise two substantially planar elements slidably connected to the two rails and situated on either side of the stages, the substantially planar elements comprising corresponding elongated axial channels configured to slidably receive projections extending from the body, and the method comprises sliding the upright members along the two rails between the cytology microarray template and substrate, and then pushing the array downwardly to contact the cytology microarray template and substrate, respectively.

39. The method of claim 34 or 35 wherein the method further comprises adjusting the stages on at least one of an x-axis and a y-axis relative to at least one of the frame and each other.

40. The method of claim 34 or 35 wherein the body comprises a plurality of floating channels each sized to releasably hold one tip, and the method further comprises placing the tips in the body to create the array of tips and removing the tips from the body after making the cytology array.

41. The method of claim 34 or 35 wherein the method further comprises removing the cytology array template and the cytology array from the stages then placing new cytology array substrates on the stages and making additional cytology arrays.

42. The method of claim 41 wherein the additional cytology arrays are made without reloading the tips.

43. The method of claim 34 or 35 wherein the method is substantially automated.

44. The method of claim 34 or 35 wherein the method is substantially manual.

45. (canceled)

46. A means for making cytology microarrays comprising:
e) a frame means for holding a body means,
f) the body means for holding an array of tips means for dispensing a microvolume of liquid,
g) at least two stage means for supporting cytology microarrays,
h) at least two upright member means operably attached to the body for moving the body means substantially normal to the stage means, and
i) at least one axial member means disposed along the frame and operably connected to the upright members for moving the upright member means between the two stage means.

47. (canceled)

48. (canceled)

49. The cytology microarray maker of claim 16 wherein the inner surface of the sleeve is substantially frustoconical and the outer surface of the pin is correspondingly substantially frustoconical.

50. The cytology microarray maker of claim 49 wherein the substantially frustoconical shape of the pin comprises a concave curve near the distal tip.

51. The cytology microarray maker of claim 16 wherein the passage is sized to substantially avoid clogging by cells when the liquid is a cytological fluid.

52. The cytology microarray maker of claim 16 wherein the sleeve and pin are configured such that the predetermined microvolume is about 0.05 μl to 0.5 μl per cycle.

53. The cytology microarray maker of claim 16 wherein the distal opening has a diameter from about 0.5 mm to 1.5 mm.

54. The cytology microarray maker of claim 16 wherein the tip is one of an array of the microvolume liquid dispenser tips, the array configured and sized to make a cytology microarray.

55. The method of claim 34, wherein said suctioning step comprises capillary action.

56. The method of claim 34, wherein said suctioning step comprises a vacuum.

57. The method of claim 35 wherein the inner surface of the sleeve is substantially frustoconical and the outer surface of the pin is correspondingly substantially frustoconical.

58. The method of claim 57 wherein the substantially frustoconical shape of the pin comprises a concave curve near the distal tip.

59. The method of claim 35 wherein the passage is sized to substantially avoid clogging by cells when the liquid is a cytological fluid.

60. The method of claim 35 wherein the sleeve and pin are configured such that the predetermined microvolume is about 0.05 μl to 0.5 μl per cycle.

61. The method of claim 35 wherein the distal opening has a diameter from about 0.5 mm to 1.5 mm.

62. The method of claim 35 wherein the tip is one of an array of microvolume liquid dispenser tips, the array configured and sized to make a cytology microarray.

63. A method of making a cytology microarray comprising a monolayer preparation of a cell suspension, said method comprising the method of claim 39 and further comprising repeating step d.

64. A cytology microarray maker comprising:
a frame, the frame operably connected to a first stage sized to support a cytology microarray template and a second stage sized to support a cytology microarray substrate;
a biasing element carrying a body holding an array of microvolume liquid dispenser tips; and
at least one axial member disposed along the frame and operably connected to the biasing element and providing a track along which the biasing element, the body, and the array of tips is movable between a first position over the first stage and a second position over the second stage;
the biasing element operable to move the array of tips in the first position between at least an extended position wherein the tips contact a plurality of cytology specimens on the cytology template and a retracted position wherein the tips do not contact the plurality of cytology specimens, and the biasing element being further operable to move the array of tips in the second position between at least an extended position wherein the tips contact the cytology microarray substrate and a retracted position wherein the tips do not contact the cytology microarray substrate.

65. The cytology microarray maker of claim 64, further comprising a third stage sized to support a second cytology microarray substrate; and wherein the at least one axial member is further configured to move the array of tips to a third position over the third stage, and the biasing element is further operable to move the array of tips in the third position between at least an extended position wherein the tips contact the second cytology microarray substrate and a retracted position wherein the tips do not contact the second cytology microarray substrate.

66. The cytology microarray maker of claim 64 wherein the at least one axial member comprises two rails extending along the frame.

67. The cytology microarray maker of claim 66 wherein the two rails form a part of the frame.

68. The cytology microarray maker of claim 64, further comprising upright members comprising two substantially planar elements that are slidably connected to the two rails and situated on either side of the stages, the substantially planar elements comprising corresponding elongated axial channels configured to slidably receive projections extending from the body.

69. The cytology microarray maker of claim 64 wherein the stages are substantially planar stands and further comprise at least x-axis and y-axis adjustment mechanisms configured to adjust positions of the stages relative to at least one of the frame and each other.

70. The cytology microarray maker of claim 64 wherein the body comprises a plurality of floating channels each sized to releasably hold one tip.

71. The cytology microarray maker of claim 64 wherein the maker is substantially automated.

72. The cytology microarray maker of claim 64 wherein the maker is substantially manually operated.

73. The cytology microarray maker of claim 64, wherein each of said tips comprise a body, an outer sleeve extending from the body, and a reciprocating pin located within the outer sleeve, wherein the outer sleeve comprises a distal opening and the pin reciprocates relative to the sleeve between a distal position wherein a distal tip of the pin extends beyond the distal opening and a proximal position, wherein the outer sleeve and the reciprocating pin are configured to cooperatively form a reservoir when the pin is in the distal position and configured to cooperatively dispense, through a passage formed between a side of the distal opening and the pin, a predetermined microvolume amount of liquid from the reservoir when the pin moves in a cycle from the distal position to the proximal position then returns to the distal position.

74. A method of making a cytology microarray, comprising:
providing a frame, the frame operably connected to a first stage sized to support a cytology microarray template and a second stage sized to support a cytology microarray substrate;
providing a biasing element carrying a body holding an array of microvolume liquid dispenser tips;
providing at least one axial member disposed along the frame and operably connected to the biasing element and providing a track along which the biasing element, the body, and the array of tips is movable between a first position over the first stage and a second position over the second stage;
the biasing element operable to move the array of tips in the first position between at least an extended position wherein the tips contact a plurality of cytology specimens on the cytology template and a retracted position wherein the tips do not contact the plurality of cytology specimens, and the biasing element being further operable to move the array of tips in the second position between at least an extended position wherein the tips contact the cytology microarray substrate and a retracted position wherein the tips do not contact the cytology microarray substrate;
loading the array of tips with liquid cytological specimens by transiently contacting the plurality of cytological specimens with the tips and suctioning up the cytological specimens;
moving the array of tips along the axial member to the second stage; and
transiently contacting the cytology microarray substrate with the array of tips;

75. The method of claim 74, further comprising providing a third stage sized to support a second cytology microarray substrate; and wherein the at least one axial member is further configured to move the array of tips to a third position over the third stage, and the biasing element is further operable to move the array of tips in the third position between at least an extended position wherein the tips contact the second cytology microarray substrate and a retracted position wherein the tips do not contact the second cytology microarray substrate; and further comprising the steps of moving the array of tips along the axial member to the third stage; and transiently contacting the cytology microarray substrate with the array of tips.

76. The method of claim 74 wherein the at least one axial member comprises two rails extending along the frame.

77. The method of claim 76 wherein the two rails form a part of the frame.

78. The method of claim 77, further comprising providing upright members comprising two substantially planar elements that are slidably connected to the two rails and situated on either side of the stages, the substantially planar elements comprising corresponding elongated axial channels configured to slidably receive projections extending from the body.

79. The method of claim 74, further comprising adjusting positions of the stages relative to at least one of the frame and each other.

80. A method of making a cytology microarray comprising a monolayer preparation of a cell suspension, said method comprising the method of claim 79 and further comprising repeating said contacting step.

81. The method of claim 74, wherein the body comprises a plurality of floating channels each sized to releasably hold one tip.

82. The method of claim 74, wherein said method is substantially automated.

83. The method of claim 74, wherein said method is substantially manually operated.

84. The method of claim 74, wherein each of said tips comprise a body, an outer sleeve extending from the body, and a reciprocating pin located within the outer sleeve, wherein the outer sleeve comprises a distal opening and the pin reciprocates relative to the sleeve between a distal position wherein a distal tip of the pin extends beyond the distal opening and a proximal position, wherein the outer sleeve and the reciprocating pin are configured to cooperatively form a reservoir when the pin is in the distal position and configured to cooperatively dispense, through a passage formed between a side of the distal opening and the pin, a predetermined microvolume amount of liquid from the reservoir when the pin moves in a cycle from the distal position to the proximal position then returns to the distal position.

85. The method of claim 74, wherein said suctioning step comprises capillary action.

86. The method of claim 74, wherein said suctioning step comprises a vacuum.
